(19) United States
(12) Patent Application Publication
(10) Pub. No.: US 2024/0376284 A1
(43) Pub. Date: Nov. 14, 2024

(54) Method for Screening Solvent for Acrylonitrile Butadiene Styrene Copolymer Extraction, Recycling Method for Waste Material, and Recycled Acrylonitrile Butadiene Styrene Copolymer and Composition

(71) Applicant: LG Chem, Ltd., Seoul (KR)

(72) Inventors: Eunbyeol Ko, Daejeon (KR); Kyoung Hoon Kim, Daejeon (KR); Seungha Kim, Daejeon (KR); Hyung Sop Kim, Daejeon (KR); Gahyeon Lee, Daejeon (KR); Seung Yong Lee, Daejeon (KR); Yoonsun Jang, Daejeon (KR); Kyeong Hwan Han, Daejeon (KR)

(73) Assignee: LG Chem, Ltd., Seoul (KR)

(21) Appl. No.: 18/688,016

(22) PCT Filed: Sep. 2, 2022
(86) PCT No.: PCT/KR2022/013219

§ 371 Date: Feb. 29, 2024

(30) Foreign Application Priority Data
Sep. 3, 2021 (KR) 10-2021-0117876
Sep. 3, 2021 (KR) 10-2021-0117878
Sep. 1, 2022 (KR) 10-2022-0110817

(51) Int. Cl. C08J 11/08

(52) U.S. Cl. CPC C08J 11/08; C08J 2355/02

(57) ABSTRACT

A method for screening a solvent for extracting acrylonitrile-butadiene-styrene (ABS) from waste using the following Equation 1:

E_{Score}=X₁ exp(−mixE)+x₂[log(x₃Mvol^{a})+log(x₄HSP^{b})]+c,

where mixE is the mixing energy between ABS and the solvent, Mvol is the molar volume of the solvent, HSP is the Hansen solubility parameter, x₁, x₂, x₃, and x₄ are each a real number from −1 to 1, a and b are each a real number from 0 to 1, and c is a real number from −10 to 10. A method for recycling waste having ABS is also provided. Additionally, a recycled acrylonitrile-butadiene-styrene copolymer and a recycled acrylonitrile-butadiene-styrene copolymer composition_are provided.

### CROSS-REFERENCE TO RELATED APPLICATIONS

This application is a national phase entry under 35 U.S.C. § 371 of International Application No. PCT/KR2022/013219 filed on Sep. 2, 2022, which claims priority to Korean Patent Application Nos. 10-2021-0117876, 10-2021-0117878, and 10-2022-0110817 filed on Sep. 3, 2021, Sep. 3, 2021, and Sep. 1, 2022, respectively, the entire contents of which are incorporated herein by reference.

### TECHNICAL FIELD

The present specification relates to a method for screening a solvent for extracting an acrylonitrile-butadiene-styrene copolymer, a method for recycling waste, a recycled acrylonitrile-butadiene-styrene copolymer, and a recycled acrylonitrile-butadiene-styrene copolymer composition.

### BACKGROUND ART

Since plastic can be molded into various shapes by heat or pressure, and the quality of the material is getting better and better, things in everyday life are being replaced with plastic, and new things using the same are being developed.

Since plastics are convenient and easy to use, demand for products made of plastics, such as plastic bags, PET bottles, disposable items, packaging products, and electronic products, is gradually increasing all over the world.

Such used and discarded plastics are either incinerated or landfilled. In the case of incineration, many contaminants harmful to the human body are discharged, so it is preferrable that the discarded plastics are landfilled rather than incinerated.

However, it takes a long time to naturally decompose most plastics after disposal, and the amount of plastics that end up in landfills is substantial, so interest in recycling plastics is increasing.

Among plastics, an acrylonitrile-butadiene-styrene copolymer (ABS) is widely used in battery/electronic products and automobile parts. Various methods for recycling ABS from waste including ABS and materials capable of minimizing damage to humans and the environment during the recycling process need to be explored.

### Technical Problem

The present specification provides a method for screening a solvent for extracting an acrylonitrile-butadiene-styrene copolymer, a method for recycling waste, a recycled acrylonitrile-butadiene-styrene copolymer, and a recycled acrylonitrile-butadiene-styrene copolymer composition.

### Technical Solution

An exemplary embodiment of the present specification provides a method for screening a solvent for extracting an acrylonitrile-butadiene-styrene copolymer. The method includes screening a solvent for extracting an acrylonitrile-butadiene-styrene copolymer from waste including the acrylonitrile-butadiene-styrene copolymer using the following Equation 1.

$${E}_{S c o r e} = {x}_{1} exp ( - m i x E ) + {x}_{2} [ log ( {x}_{3} {Mvol}^{a} ) + log ( {x}_{4} H S {P}^{b} ) ] + c \qquad [ Equation 1 ]$$

In Equation 1, mixE is the mixing energy between the acrylonitrile-butadiene-styrene copolymer and the solvent,
Mᵥₒₗ is the molar volume of the solvent,
HSP is the Hansen solubility parameter,
X₁, X₂, X₃, and x₄ are each a real number from −1 to 1,
a and b are each a real number from 0 to 1, and
c is a real number from −10 to 10.

Another exemplary embodiment of the present specification provides a method for recycling waste including an acrylonitrile-butadiene-styrene copolymer. The method includes screening a solvent for extracting an acrylonitrile-butadiene-styrene copolymer using the above-described method for screening a solvent and extracting the acrylonitrile-butadiene-styrene copolymer from waste including the acrylonitrile-butadiene-styrene copolymer using the screened solvent.

Still another exemplary embodiment of the present specification provides a recycled acrylonitrile-butadiene-styrene copolymer extracted from waste including an acrylonitrile-butadiene-styrene copolymer using the above-described screened solvent.

Yet another exemplary embodiment of the present specification provides a recycled acrylonitrile-butadiene-styrene copolymer composition including: an acrylonitrile-butadiene-styrene copolymer extracted from waste including an acrylonitrile-butadiene-styrene copolymer, any one good solvent of solvents with an E_{score} value of more than 0 according to the following Equation 1, and any one non-solvent of solvents with an E_{score} value of 0 or less according to the following Equation 1.

$${E}_{S c o r e} = {x}_{1} exp ( - m i x E ) + {x}_{2} [ log ( {x}_{3} {Mvol}^{a} ) + log ( {x}_{4} H S {P}^{b} ) ] + c \qquad [ Equation 1 ]$$

In Equation 1, mixE is the mixing energy between the acrylonitrile-butadiene-styrene copolymer and the solvent,
Mᵥₒₗ is the molar volume of the solvent,
HSP is the Hansen solubility parameter,
X₁, X₂, X₃, and X₄ are each a real number from −1 to 1,
a and b are each a real number from 0 to 1, and
c is a real number from −10 to 10.

### Advantageous Effects

According to an exemplary embodiment of the present specification, it is possible to find various solvents capable of being used in the process of extracting an acrylonitrile-butadiene-styrene copolymer from waste including an acrylonitrile-butadiene-styrene copolymer.

According to another exemplary embodiment of the present specification, it is possible to find various good solvent-non-solvent combinations suitable for the process of extracting an acrylonitrile-butadiene-styrene copolymer from waste including an acrylonitrile-butadiene-styrene copolymer.

### BRIEF DESCRIPTION OF DRAWINGS

FIG. 1 is a graph showing E_{score} values calculated by Equation 1 according to the present specification.

### DETAILED DESCRIPTION

Hereinafter, the present specification will be described in detail.

The present specification has been made in an effort to provide a parameter capable of classifying and evaluating a solvent available for extracting an acrylonitrile-butadiene-styrene copolymer (ABS) from waste by predicting the solvent. Through this, a new solvent capable of extracting ABS may be discovered. Here, the solvent capable of extracting ABS means all solvents used for extracting ABS from waste, and specifically, includes not only a good solvent that has high solubility for ABS and thus can dissolve ABS from waste, but also a non-solvent that can obtain ABS by precipitating ABS from a good solvent in which ABS is dissolved.

An exemplary embodiment of the present specification provides a method for screening a solvent for extracting ABS, the method including screening a solvent for extracting an acrylonitrile-butadiene-styrene copolymer from waste including the acrylonitrile-butadiene-styrene copolymer using the following Equation 1.

$${E}_{S c o r e} = {x}_{1} exp ( - m i x E ) + {x}_{2} [ log ( {x}_{3} {Mvol}^{a} ) + log ( {x}_{4} H S {P}^{b} ) ] + c \qquad [ Equation 1 ]$$

In Equation 1, mixE is the mixing energy between the acrylonitrile-butadiene-styrene copolymer and the solvent, Mᵥₒₗ is the molar volume of the solvent, HSP is the Hansen solubility parameter, X₁, X₂, X₃, and X₄ are each a real number from −1 to 1, a and b are each a real number from 0 to 1, and c is a real number from −10 to 10.

In an exemplary embodiment of the present specification, the affinity between ABS and a solvent is calculated using data such as the mixing energy between ABS and the solvent, Hasen solubility parameter and molar volume, and based on the calculated result, it is possible to classify a good solvent that is mixed well with ABS, that is, a solvent capable of separating ABS from waste.

In an exemplary embodiment of the present specification, Equation 1 means a solubility score in consideration of factors capable of determining the solubility between ABS and a solvent along with the variables of experimental conditions such as temperature. The higher the solubility in ABS, the higher the value of Equation 1, and specifically, a good solvent and a non-solvent are classified based on the value of 0.

In Equation 1 of an exemplary embodiment of the present specification, mixE is the mixing energy between the acrylonitrile-butadiene-styrene copolymer and the solvent, and has a unit of kcal/mol.

Here, the mixing energy means the amount of change in internal energy caused by mixing several materials at the same temperature, and generally, is accompanied by the energy change of heat generation or absorption in mixing. Specifically, since a contact among only homogeneous molecules in a pure system is changed to a contact between some heterogeneous molecules by mixing, a mixing energy is the change in energy when interactions between homogeneous molecules decrease and new interactions between heterogeneous molecules occur. Further, a lower mixing energy value when materials are mixed means that the solubility of each other is higher.

In Equation 1 of an exemplary embodiment of the present specification, the mixE can be calculated using a Conductor like Screening Model for Real Solvents (COSMO-RS) theory, and COSMO-RS predicts thermodynamic data, which are properties of each solvent, with molecular structure information based on unimolecular quantum chemical calculations. The mixE can be calculated using the COSMOtherm software (COSMOlogic GmbH & Co. KG), which can conveniently calculate the mixE.

In Equation 1 of an exemplary embodiment of the present specification, Mᵥₒₗ is the molar volume of the solvent, and the molar volume is the volume occupied by one mole of molecules and is also called mole volume or gram molecular volume. The molar volume is the product of specific volume and molecular weight, in other words, the molecular weight divided by density, and has a unit of cm3/mol.

In Equation 1 of an exemplary embodiment of the present specification, HSP is the Hansen solubility parameter, and specifically, means the difference in Hansen parameter between two materials of a solute and a solvent. HSP is a value proportional to the solubility of two materials, and through this, the solubility of two materials may be calculated. When two materials have similar properties, the HSP value is low because the Hansen parameter values are similar, and the two materials may be expected to be well dissolved in each other through the HSP value.

In Equation 1 of an exemplary embodiment of the present specification, HSP may be calculated by the following Equation 2, the δd, δp and δh of two materials may be obtained when an HSPiP software that conveniently calculates the HSP is used, and when the corresponding value is applied to the following Equation 2, the HSP value with the corresponding solvent may be calculated and has a unit of MPa0.5.

$$HSP = \sqrt{\begin{matrix}4 {( δ {d}_{ABS} - δ {d}_{solvent} )}^{2} + \\ {( δ {p}_{ABS} - δ {p}_{solvent} )}^{2} + {( δ {h}_{ABS} - δ {h}_{solvent} )}^{2}\end{matrix}} \qquad [ Equation 2 ]$$

δd=Solubility factor caused by nonpolar dispersion bonds.
δp=Solubility factor caused by polar bonds due to permanent dipoles.
δh=Solubility factor caused by hydrogen bonds.

In an exemplary embodiment of the present specification, x₁ is a control variable determined by experimental conditions such as temperature. x₁ is a real number from −1 to 1, specifically a real number from 0 to 1, and more specifically a real number from 0 to 0.5, and may be preferably 0.25.

In an exemplary embodiment of the present specification, x₂ is a control variable determined by experimental conditions such as temperature. x₂ is a real number from −1 to 1, specifically a real number from 0 to 1, and more specifically a real number from 0 to 0.5, and may be preferably 0.45.

In an exemplary embodiment of the present specification, x₃ is a control variable determined by experimental conditions such as temperature. x₃ is a real number from −1 to 1, specifically a real number from 0 to 1, and more specifically a real number from 0 to 0.5, and may be preferably 0.11.

In an exemplary embodiment of the present specification, x₄ is a control variable determined by experimental conditions such as temperature. x₄ is a real number from −1 to 1, specifically a real number from 0 to 1, and more specifically a real number from 0.5 to 1, and may be preferably 1.

In an exemplary embodiment of the present specification, a is a control variable determined by experimental conditions such as temperature. a is a real number from 0 to 1, specifically a real number from 0.5 to 1, and may be preferably 0.5.

In an exemplary embodiment of the present specification, b is a control variable determined by experimental conditions such as temperature. b is a real number from 0 to 1, specifically a real number from 0.5 to 1, and may be preferably 1.

In an exemplary embodiment of the present specification, c is a control variable determined by experimental conditions such as temperature. c is a real number from −10 to 10, specifically a real number from −1 to 0, and may be preferably-0.9.

In an exemplary embodiment of the present specification, under an experimental condition of 25° C., x₁ was set to 0.25, x₂ to 0.45, x₃ to 0.11, x₄ to 1, a to 0.5, b to 1, and c to −0.9, in consideration of changes in factors depending on temperature.

In an exemplary embodiment of the present specification, a solvent with an E_{score} value of more than 0 according to Equation 1 may be determined to be a good solvent for an acrylonitrile-butadiene-styrene copolymer. In this case, a good solvent means a solvent capable of dissolving an acrylonitrile-butadiene-styrene copolymer, and is a solvent capable of dissolving and extracting the acrylonitrile-butadiene-styrene copolymer from waste.

In an exemplary embodiment of the present specification, when x₁ is 0.25, x₂ is 0.45, x₃ is 0.11, x₄ is 1, a is 0.5, b is 1, and c is-0.9, a solvent with an E_{score} value of more than 0 according to Equation 1 may be determined to be a good solvent for an acrylonitrile-butadiene-styrene copolymer.

In an exemplary embodiment of the present specification, the solvent with an E_{score} value of more than 0 according to Equation 1 is not particularly limited, and the solvent may be selected as a good solvent as long as the solvent satisfies an E_{score} value of more than 0 according to Equation 1.

In an exemplary embodiment of the present specification, a solvent with an E_{score} value of 0 or less according to Equation 1 may be determined to be a non-solvent for an acrylonitrile-butadiene-styrene copolymer. In this case, a non-solvent means a solvent having a low solubility for an acrylonitrile-butadiene-styrene copolymer, and is a solvent that can be used when precipitating an acrylonitrile-butadiene-styrene copolymer from an extracted acrylonitrile-butadiene-styrene copolymer solution.

In an exemplary embodiment of the present specification, when x₁ is 0.25, x₂ is 0.45, x₃ is 0.11, x₄ is 1, a is 0.5, b is 1, and c is-0.9, a solvent with an E_{score} value of 0 or less according to Equation 1 may be determined to be a non-solvent for an acrylonitrile-butadiene-styrene copolymer.

In an exemplary embodiment of the present specification, the solvent with an E_{score} value of 0 or less according to Equation 1 is not particularly limited, and the solvent may be selected as a non-solvent as long as the solvent satisfies an E_{score} value of 0 or less according to Equation 1.

In an exemplary embodiment of the present specification, it is possible to further include selecting any one of solvents with an E_{score} value of more than 0 according to Equation 1 as a good solvent for extracting an acrylonitrile-butadiene-styrene copolymer from waste including the acrylonitrile-butadiene-styrene copolymer. It is also possible to further include selecting any one of solvents with an E_{score} value of 0 or less according to Equation 1 as a non-solvent for extracting an acrylonitrile-butadiene-styrene copolymer from waste including the acrylonitrile-butadiene-styrene copolymer.

In an exemplary embodiment of the present specification, a difference between the E_{score} value of the good solvent and the E_{score} value of the non-solvent may be 0.1 or more, 0.2 or more, 0.3 or more, 0.4 or more, 0.5 or more, 0.6 or more, 0.7 or more, 0.8 or more, 0.9 or more, 1 or more, 1.1 or more, 1.2 or more, 1.3 or more, 1.4 or more, 1.5 or more, 1.6 or more, 1.7 or more, 1.8 or more, 1.9 or more, 2 or more, 2.1 or more, 2.2 or more, 2.3 or more, 2.4 or more, 2.5 or more, 2.6 or more, 2.7 or more, 2.8 or more, 2.9 or more, 3 or more, 3.1 or more, 3.2 or more, 3.3 or more, 3.4 or more, 3.5 or more, 3.6 or more, 3.7 or more, 3.8 or more, 3.9 or more, 4 or more, 4.1 or more, 4.2 or more, 4.3 or more, 4.4 or more, 4.5 or more, 4.6 or more, 4.7 or more, 4.8 or more, 4.9 or more, 5 or more, 5.1 or more, 5.2 or more, 5.3 or more, 5.4 or more, 5.5 or more, 5.6 or more, 5.7 or more, 5.8 or more, 5.9 or more, or 6 or more.

In an exemplary embodiment of the present specification, the good solvent and the non-solvent may each have a TD50 (Rat) of 15 mg/kg or more predicted by the Discovery Studio TOPKAT Module of BIOVIA. In this case, TD50 is a dose at which 50% of experimental animals die or produce undesirable toxic reactions when a test material is administered to experimental animals, and is usually expressed as mg per kg of body weight. Therefore, since lower TD50 values imply undesirable toxicity at small amounts of material, the material is more toxic. Conversely, a higher TD50 means that the material is relatively harmless because the material is not harmful to the body even though a large amount of material is ingested. TD50 values vary depending on experimental animals (for example, mouse, rat, and the like), and the TD50 values for rats as experimental animals were used in the present invention.

Another exemplary embodiment of the present specification provides a method for recycling waste including an acrylonitrile-butadiene-styrene copolymer, the method including screening a solvent for extracting an acrylonitrile-butadiene-styrene copolymer using the above-described method for screening a solvent, and extracting the acrylonitrile-butadiene-styrene copolymer from waste including the acrylonitrile-butadiene-styrene copolymer using the screened solvent.

In the present specification, the description of the screening step in the waste recycling method may reference the above-described method for screening a solvent for extracting ABS.

In an exemplary embodiment of the present specification, the extracting of the acrylonitrile-butadiene-styrene copolymer may include a dissolution process of bringing waste including the acrylonitrile-butadiene-styrene copolymer into contact with a good solvent with an E_{score} value of more than 0 according to Equation 1 and obtaining an acrylonitrile-butadiene-styrene copolymer solution by dissolving the acrylonitrile-butadiene-styrene copolymer in the waste in the good solvent.

In an exemplary embodiment of the present specification, the extracting of the acrylonitrile-butadiene-styrene copolymer may include a dissolution process of bringing waste including the acrylonitrile-butadiene-styrene copolymer into contact with any one good solvent of solvents with an E_{score} value of more than 0 according to Equation 1 and obtaining an acrylonitrile-butadiene-styrene copolymer solution by dissolving the acrylonitrile-butadiene-styrene copolymer in the waste in the good solvent.

The extracting of the acrylonitrile-butadiene-styrene copolymer may further include a precipitation process of precipitating the acrylonitrile-butadiene-styrene copolymer from the solution by bringing the solution into contact with any one non-solvent of solvents with an E_{score} value of 0 or less according to Equation 1.

Still another exemplary embodiment of the present specification provides a method for recycling waste including an acrylonitrile-butadiene-styrene copolymer, the method including selecting a good solvent and a non-solvent for extracting an acrylonitrile-butadiene-styrene copolymer using the above-described method for screening the solvent, bringing waste including the acrylonitrile-butadiene-styrene copolymer into contact with the good solvent and obtaining an acrylonitrile-butadiene-styrene copolymer solution by dissolving the acrylonitrile-butadiene-styrene copolymer in the waste in the good solvent (hereinafter, referred to as a dissolution process), and precipitating the acrylonitrile-butadiene-styrene copolymer from the solution by bringing the solution into contact with the non-solvent (hereinafter, referred to as a precipitation process).

In an exemplary embodiment of the present specification, the extracting of the acrylonitrile-butadiene-styrene copolymer may further include a separation process of separating a solid material from the acrylonitrile-butadiene-styrene copolymer solution obtained by the dissolution process. In this case, the solid material is a solid that is not dissolved in a good solvent of an acrylonitrile-butadiene-styrene copolymer, and corresponds to impurities.

In an exemplary embodiment of the present specification, the extracting of the acrylonitrile-butadiene-styrene copolymer may further include a separating process of separating the acrylonitrile-butadiene-styrene copolymer precipitated by the precipitation process from the solution.

In an exemplary embodiment of the present specification, the extracting of the acrylonitrile-butadiene-styrene copolymer may further include a rinsing process of rinsing the acrylonitrile-butadiene-styrene copolymer precipitated by the precipitation process.

In an exemplary embodiment of the present specification, the extracting of the acrylonitrile-butadiene-styrene copolymer may further include a drying process of drying the acrylonitrile-butadiene-styrene copolymer precipitated by the precipitation process.

Still another exemplary embodiment of the present specification provides a recycled acrylonitrile-butadiene-styrene copolymer extracted from waste including an acrylonitrile-butadiene-styrene copolymer using the above-described screened solvent.

Yet another exemplary embodiment of the present specification provides a recycled acrylonitrile-butadiene-styrene copolymer composition including an acrylonitrile-butadiene-styrene copolymer extracted from waste including an acrylonitrile-butadiene-styrene copolymer, any one good solvent of solvents with an E_{score} value of more than 0 according to the following Equation 1, and any one non-solvent of solvents with an E_{score} value of 0 or less according to the following Equation 1.

$${E}_{S c o r e} = {x}_{1} exp ( - m i x E ) + {x}_{2} [ log ( {x}_{3} {Mvol}^{a} ) + log ( {x}_{4} H S {P}^{b} ) ] + c \qquad [ Equation 1 ]$$

In Equation 1, mixE is the mixing energy between the acrylonitrile-butadiene-styrene copolymer and the solvent,
Mᵥₒₗ is the molar volume of the solvent,
HSP is the Hansen solubility parameter,
X₁, X₂, X₃, and x₄ are each a real number from −1 to 1,
a and b are each a real number from 0 to 1, and
c is a real number from −10 to 10.

Here, for the description on Equation 1, the above-described description is referenced to avoid duplication.

In an exemplary embodiment of the present specification, a recycled acrylonitrile-butadiene-styrene copolymer composition means a state in which an acrylonitrile-butadiene-styrene copolymer extracted by the good solvent from waste including an acrylonitrile-butadiene-styrene copolymer, a good solvent used during the extraction of the acrylonitrile-butadiene-styrene copolymer, and a non-solvent which separates and precipitates the extracted acrylonitrile-butadiene-styrene copolymer from the good solvent are all included. For the acrylonitrile-butadiene-styrene copolymer extracted depending on the ratio of the good solvent and the non-solvent, the acrylonitrile-butadiene-styrene copolymer dissolved in the good solvent and the precipitated acrylonitrile-butadiene-styrene copolymer may coexist or most of the acrylonitrile-butadiene-styrene copolymer may be precipitated and settled into a solid state.

In an exemplary embodiment of the present specification, when the weight of the good solvent in the recycled acrylonitrile-butadiene-styrene copolymer composition is set to 100, the content of the non-solvent is at least 100 parts by weight, and the solute may be precipitated by adding the non-solvent in an amount, which is equal to or more than the weight of the good solvent. The higher the content of non-solvent, the easier it is to precipitate the solute and the process time can be shortened, but in order to increase the purity in the solute, it is preferred to adjust the content of the non-solvent in consideration of the appropriate precipitation rate and the particle size of the precipitated solute.

In an exemplary embodiment of the present specification, when the weight of the good solvent is set to 100, the content of the non-solvent may be 100 parts by weight or more, 150 parts by weight or more, 200 parts by weight or more, 250 parts by weight or more, 300 parts by weight or more, 350 parts by weight or more, 400 parts by weight or more, 450 parts by weight or more or 500 parts by weight or more, 1000 parts by weight or less, 900 parts by weight or less, 800 parts by weight or less, 700 parts by weight or less, or 600 parts by weight or less.

In an exemplary embodiment of the present specification, the content of the good solvent is not particularly limited as long as the ABS in the waste can be dissolved. When the weight of the waste including the acrylonitrile-butadiene-styrene copolymer is set to 100, the content of the good solvent is at least 100 parts by weight, and the solute may be precipitated by adding the good solvent in an amount, which is equal to or more than the weight of the waste.

In an exemplary embodiment of the present specification, when the weight of the waste including the acrylonitrile-butadiene-styrene copolymer is set to 100, the content of the good solvent may be 100 parts by weight or more, 150 parts by weight or more, 200 parts by weight or more, 250 parts by weight or more, 300 parts by weight or more, 350 parts by weight or more, 400 parts by weight or more, 450 parts by weight or more or 500 parts by weight or more, 1000 parts by weight or less, 900 parts by weight or less, 800 parts by weight or less, 700 parts by weight or less, or 600 parts by weight or less.

In an exemplary embodiment of the present specification, the good solvent and the non-solvent are each independently any one of an alcohol-based solvent, a ketone-based solvent, an ester-based solvent, an ether-based solvent, a polar nonprotic solvent, a hydrocarbon solvent, or a halogen-containing solvent.

In an exemplary embodiment of the present specification, the good solvent is any one of an alcohol-based solvent, a ketone-based solvent, an ester-based solvent, an ether-based solvent, a polar nonprotic solvent, a hydrocarbon solvent, or a halogen-containing solvent. In an exemplary embodiment of the present specification, the good solvent has an E_{score} value of more than 0 according to Equation 1, and is selected in consideration of the difference in solubility between the non-solvent and the acrylonitrile-butadiene-styrene copolymer used together. The good solvent may be any one selected among dimethyl sulfoxide (DMSO), n-methyl-2-pyrrolidinone, n, n-dimethylacetamide, Tetrahydrofuran (THF), 2-methylpyridine, 3,5-dimethylpyridine, acetylacetone, 1-methylimidazole, dimethyl isosorbide, gamma-valerolactone, 1,3-benzodioxole, diglyme, dichloromethane, chloroform, 1,1,2,2-tetrachloroethane, cyclopentanone, 2-cyclohexen-1-one, cyclohexanone, 2-pentanone, propanone, dimethylformamide, benzyl alcohol, carbon tetrachloride, 1,4-dioxane, trichloroethylene, butanone, oxalyl chloride, acetyl chloride, ethyl acetate, 3-methyl-2-butanone, 4-methylpyridine, acetyl acetate, 3-picoline, 2,3-pentanedione, morpholine, isopropyl acetate, pyrrole, 2-methylcyclopentanone, 2-methylpyrazine, cycloheptanone, 2,5-dimethylpyrazine, propanoic anhydride, 1,1-ethanediol diacetate, propionyl chloride, ethyl carbonochloridate, 1,1-dichloroethane, 3,6-dioxaoctane, 3,3-dimethyl-2-butanone, 3-methylcyclohexanone, 1,1-dichloro-2,2,2-trifluoroethane, chloroethyl chloroformate, methyl dichloroacetate, dichloroacetyl chloride, triethyl phosphate, dimethyl phthalate, chloroacetyl chloride, 3-chloropropanoyl chloride, methyl-5-(dimethylamino)-2-methyl-5-oxopentanoate, diethylene glycol diacetate, diethyl malate, dimethyl 1,4-cyclohexanedicarboxylate, diethyl adipate, diisopropyl methylphosphonate, dimethylcarbamoyl chloride, oxybis [chloromethane], isonicotinic acid ethyl ester, diethyl glutarate, ethylene sulfite, dimethyl adipate, dimethyl methylglutarate, ethyl succinate, n, n-diethyl-m-toluamide, 2-(2-ethoxyethoxy) ethyl acetate, ethyl chloroacetate, methoxyacetyl chloride, chloroacetic acid methyl ester, dimethyl glutarate, diethyl malonate, methyl carbonochloridate, methyl 2-hydroxybenzoate, 2-chlorophenol, ethyl oxalate, 2-acetyloxyethyl acetate, dimethyl succinate, 1,1,2-trichloroethane, 2-chloropyridine, 1-(2-hydroxyethyl) pyrrolidin-2-one, 2-[2-(diethylamino) ethoxy] ethanol, dimethyl malonate, 2,5-ditert-butylphenol, n-formylmorpholine, 4-morpholinepropanamine, 3,4-dihydrochromen-2-one, 3-methoxy-n, n-dimethylpropanamide, 4-(2-hydroxyethyl) morpholine, isopropyl acetoacetate, 2-acetylpyridine, 4-methoxyacetophenone, 3-methyl-2-oxazolidone, 1-ethoxy-2-(2-ethoxyethoxy) ethane, 2,6,6-trimethylcyclohex-2-ene-1,4-dione, 1,3-dimethyl-2-imidazolidinone, 3-methoxybutyl acetate, 2-isopropoxyethyl acetate, ethyl 3-ethoxypropionate, octahydrocoumarin, ethyl acetoacetate, 1-(2-hydroxyphenyl) ethanone, methyl benzoate, 1-(3-methoxypropoxy) propan-1-ol, n-sec-butylpyrrolidone, 2-methoxypropyl acetate, 2-ethoxyethanol acetate, 1-methoxy-2-propyl acetate, paraldehyde, tetramethylurea, methyl acetoacetate, 2-tert-butyl-4-methylphenol, 2-tert-butyl-5-methylphenol, 4-methoxyphenol, diethylene glycol monoethyl ether, 2-methoxyethyl acetate, diethyl carbonate, ethyl lactate, 1-tetralone, 2-tert-butylphenol, thymol, 3-tert-butylphenol, 2-methyl-5-propan-2-ylphenol, p-(sec-butyl) phenol, 1-ethylpyrrolidin-2-one, or 2-(2-methoxyethoxy) ethanol, but is not limited thereto. In an exemplary embodiment of the present specification, the non-solvent is any one of an alcohol-based solvent, a ketone-based solvent, an ester-based solvent, an ether-based solvent, a polar nonprotic solvent, a hydrocarbon solvent and a halogen-containing solvent.

In an exemplary embodiment of the present specification, the non-solvent has an E_{score} value of 0 or less according to Equation 1, and is selected in consideration of the difference in solubility between the good solvent and the acrylonitrile-butadiene-styrene copolymer used together. The non-solvent may be any one selected among 2-methylfuran, 1-methyl-1H-pyrrole, thiophene, diethylene glycol monobutyl ether, 2-butoxyethanol, methanol, ethanol, formamide, 2-[(2-methylpropan-2-yl) oxymethyl] oxirane, methyl lactate, 1,3-dithiolane, n-ethyl-morpholine, 2-methylindole, 3-ethyl-5-methylphenol, 2,4,5-trimethylphenol, ethyl 2-methylpropanoate, sec-butyl acetate, propyl propionate, ethyl butyrate, 2-methylpropyl acetate, n-butyl acetate, acetophenone, benzofuran, 4-isopropylpyridine, 3-methoxy-3-methyl-1-butanol, 1-(dimethylamino) propan-2-ol, methyl isobutyrate, methyl butyrate, ethyl propionate, propyl acetate, pyrimidine, 2,6-dimethylpyridine, 2,5-dimethylpyridine, 2,4-dimethylpyridine, 4-ethylpyridine, 3,4-dimethylpyridine, ethylene glycol methyl ethyl ether, 2,2-dimethoxypropane, 3-methoxy-1-butanol, 2-(dimethylamino)-ethanol, 1,1-dimethoxyethane, 1-hydroxypropan-2-one, 4-methylpentan-2-one, 3-hexanone, 2-hexanone, tetrahydrothiophene, 2,3-dihydropyran, 2-methyltetrahydrofuran, toluene, trimethylphosphine, benzene, 2-propanol, acetonitrile, or 2-methyl-1-buten-3-yne, but is not limited thereto.

Yet another exemplary embodiment of the present specification provides a recycled acrylonitrile-butadiene-styrene copolymer obtained by filtering the above-described composition.

In another exemplary embodiment of the present specification, for an acrylonitrile-butadiene-styrene copolymer extracted by the good solvent from waste including the acrylonitrile-butadiene-styrene copolymer in a waste recycled acrylonitrile-butadiene-styrene copolymer composition, most of the acrylonitrile-butadiene-styrene copolymer may be precipitated by the non-solvent and settled into a solid state. The recycled acrylonitrile-butadiene-styrene copolymer may be obtained by filtering the composition including the acrylonitrile-butadiene-styrene copolymer in the precipitated state.

In still another exemplary embodiment of the present specification, the recycled acrylonitrile-butadiene-styrene copolymer includes all the states in which the composition has been filtered and in which excess solvents have been removed by drying the composition after filtration.

In an exemplary embodiment of the present specification, the recycled acrylonitrile-butadiene-styrene copolymer includes an additive derived from waste. In this case, the additive derived from waste is not particularly limited as long as the additive is added for preparing the waste, and examples thereof include a flame retardant, and the like. Since an additive such as a flame retardant is already included when products are produced using the recycled acrylonitrile-butadiene-styrene copolymer, there is an advantage in that the additive such as a flame retardant is not added or the addition amount can be reduced.

In an exemplary embodiment of the present specification, the waste is not particularly limited as long as it includes ABS, but may be, for example, a waste home appliance including ABS, usually a refrigerator, a washing machine, a television set, and the like.

In an exemplary embodiment of the present specification, the recycled acrylonitrile-butadiene-styrene copolymer is ABS extracted by solvent extraction, and low-molecular weight ABSs are filtered out during solvent extraction, resulting in a higher average molecular weight than ABS prepared by polymerization or ABS in waste. Furthermore, as the average molecular weight of ABS is changed, dynamic physical properties affected by the average molecular weight such as the glass transition temperature (Tg) thereof are changed, so dynamic physical properties such as the glass transition temperature (Tg) are also increased as the average molecular weight of ABS is increased.

### Examples

Hereinafter, the present specification will be described in more detail through Examples. However, the following Examples are provided only for exemplifying the present specification, but are not intended to limit the present specification.

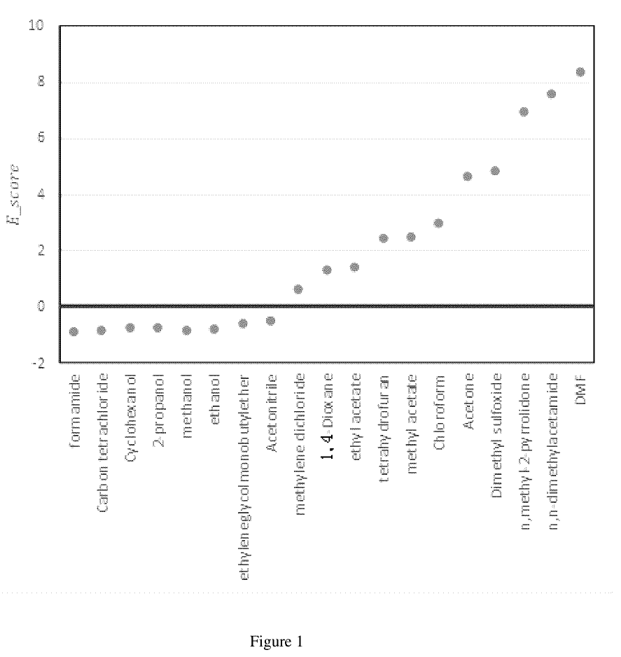

FIG. 1 illustrates values of E_{score} for actual solvents based on literature values for the solubility of ABS in solvents as an example.

When variables X₁, X₂, X₃, X₄, a, b, and c determined by experimental conditions such as a temperature of 25° C. are 0.25, 0.45, 0.11, 1, 0.5, 1, and −0.9, respectively, mixE, Mᵥₒₗ and HSP are as shown in the following Table 1, and E_{score} values calculated therefrom are shown in Table 1.

TABLE 1

| | | | | | Literature |
|---|---|---|---|---|---|
| Solvent | mixE | Mvol | HSP | Escore | value |
| Acetone | −3.10 | 73.80 | 8.07 | 4.58 | Good |
| Acetonitrile | −0.64 | 52.90 | 11.22 | −0.47 | Bad |
| Carbon tetrachloride | 2.84 | 97.10 | 8.78 | −1.12 | Bad |
| Chloroform | −2.72 | 80.50 | 8.09 | 2.85 | Good |
| Cyclohexanol | 1.99 | 105.70 | 11.18 | −0.84 | Bad |
| Dimethyl sulfoxide | −3.14 | 71.30 | 7.98 | 4.80 | Good |
| 1,4-Dioxane | −2.15 | 86.30 | 5.30 | 1.10 | Good |
| N,N-Di methyl acetamide | −3.52 | 93.00 | 6.78 | 7.45 | Good |
| N,N-Di methyl formamide | −3.61 | 77.40 | 7.96 | 8.28 | Good |
| Ethanol | 1.26 | 58.60 | 15.98 | −0.79 | Bad |
| Ethyl acetate | −2.19 | 98.60 | 9.14 | 1.31 | Good |
| Ethyleneglycolmono- | −0.27 | 170.40 | 9.37 | −0.53 | Bad |
| butylether | | | | | |
| Formamide | 7.19 | 39.90 | 21.35 | −0.84 | Bad |
| Methanol | 1.28 | 40.60 | 19.58 | −0.79 | Bad |
| Methyl acetate | −2.60 | 79.80 | 8.85 | 2.43 | Good |
| Methylene dichloride | −3.30 | 64.40 | 6.11 | 5.75 | Good |
| N-Methyl-2-pyrrolidone | −3.44 | 96.60 | 3.92 | 6.71 | Good |
| 2-Propanol | 1.38 | 76.90 | 14.00 | −0.80 | Bad |
| Tetrahydrofuran | −2.57 | 81.90 | 7.63 | 2.30 | Good |

The literature values in Table 1 show experimental values in Peng et al, J. Macromolecular Science, Part B, 2010, 49:5, 864 (DOI: 10.1080/00222341003603693). In the paper, when ABS was experimentally dissolved in a solvent, it was tested whether ABS was well dissolved or not dissolved as GOOD/BAD, and when the E_{score} values of each solvent are compared with the experimental values in the paper, it can be seen that the values express the actual solubility well.

In this case, the experiment in the paper was performed at 25° C., and the values of E_{score} in Table 1 were also calculated at the same temperature. [Experimental Examples]

A solution was prepared by adding an ABS waste sample to the good solvent shown in the following Table 2 and stirring the resulting mixture at 120 rpm at room temperature for 2 hours. Thereafter, ABS was precipitated by dropping a non-solvent shown in the following Table 2 into the solution. In this case, the weight ratio of waste ABS: good solvent: non-solvent is 1:10: 10.

After all non-solvents were dropped, a filtered solid was obtained by filtering the reaction solution with a filter. The filtered solid was further washed with the same non-solvent as the above non-solvent and dried to obtain recycled ABS.

TABLE 2

| | | | Recovered | Recovery |
|---|---|---|---|---|
| | Good solvent | Non-solvent | amount (g) | rate (%) |
| Experimental | Benzyl alcohol | n-butyl | 4.85 | 60.625 |
| Example 1 | | acetate | | |
| Experimental | | 2-propanol | 5.73 | 71.625 |
| Example 2 | | | | |
| Experimental | | Toluene | 0.98 | 12.25 |
| Example 3 | | | | |
| Experimental | Dichloromethane | n-butyl | 4.15 | 51.875 |
| Example 4 | | acetate | | |
| Experimental | | 2-propanol | 7.01 | 87.625 |
| Example 5 | | | | |
| Experimental | | Toluene | 2.2 | 27.5 |
| Example 6 | | | | |
| Experimental | THF | n-butyl | 4.84 | 60.5 |
| Example 7 | | acetate | | |
| Experimental | | 2-propanol | 7 | 87.5 |
| Example 8 | | | | |
| Experimental | | Toluene | 3.63 | 45.375 |
| Example 9 | | | | |

E_{score} values of the solvents used in Table 2 are shown in the following Table 3.

Referring to Table 2 based on the E_{score} values in the following Table 3, Experimental Example 5 using dichloromethane having the highest E_{score} among the good solvents used in the Experimental Examples and 2-propanol having the lowest Encore among the non-solvents used in the Experimental Examples shows the highest recovery rate. Furthermore, Experimental Example 3 using benzyl alcohol having the lowest E_{score} among the good solvents used in the Experimental Examples and toluene having the highest Encore among the non-solvents used in the Experimental Examples shows the lowest recovery rate.

TABLE 3

| | E_{score} values | Classification |
|---|---|---|
| Benzyl alcohol | 0.64 | Good solvent |
| Dichloromethane | 5.75 | Good solvent |
| THF | 2.30 | Good solvent |
| n-butyl acetate | −0.59 | Non-solvent |
| 2-propanol | −0.80 | Non-solvent |
| Toluene | −0.48 | Non-solvent |

1. A method for screening a solvent for extracting an acrylonitrile-butadiene-styrene copolymer, comprising:
screening a solvent for extracting the acrylonitrile-butadiene-styrene copolymer from a waste comprising-including the acrylonitrile-butadiene-styrene copolymer using the following Equation 1:
$${E}_{S c o r e} = {x}_{1} exp ( - m i x E ) + {x}_{2} [ log ( {x}_{3} {Mvol}^{a} ) + log ( {x}_{4} H S {P}^{b} ) ] + c \qquad [ Equation 1 ]$$
wherein mixE is a mixing energy between the acrylonitrile-butadiene-styrene copolymer and the solvent,
Mᵥₒₗ is a molar volume of the solvent,
HSP is a Hansen solubility parameter,
X₁, X₂, X₃, and x₄ are each a real number from −1 to 1,
a and b are each a real number from 0 to 1, and
c is a real number from −10 to 10.

2. The method of claim 1, wherein the mixing energy is a value calculated using a COSMO-RS theory.

3. The method of claim 1, further comprising: selecting any one of the solvents with an E_{score} value of more than 0 according to Equation 1 as a good solvent for the acrylonitrile-butadiene-styrene copolymer; and
selecting any one solvents with an E_{score} value of 0 or less according to Equation 1 as a non-solvent for the acrylonitrile-butadiene-styrene copolymer.

4. The method of claim 3, wherein the good solvent and the non-solvent each have a TD50 value for rats of 15 mg/kg or more calculated by the Discovery Studio TOPKAT Module of BIOVIA.

5. A method for recycling the waste including the acrylonitrile-butadiene-styrene copolymer, comprising:
screening the solvent for extracting thean acrylonitrile-butadiene-styrene copolymer from the waste according to claim 1; and
extracting the acrylonitrile-butadiene-styrene copolymer from the waste using the screened solvent.

6. The method of claim 5, wherein the extracting of the acrylonitrile-butadiene-styrene copolymer comprises:
a dissolution process of bringing the waste including the acrylonitrile-butadiene-styrene copolymer into contact with a good solvent with an E_{score} value of more than 0 according to Equation 1 and obtaining an acrylonitrile-butadiene-styrene copolymer solution by dissolving the acrylonitrile-butadiene-styrene copolymer in the waste in the good solvent; and
a precipitation process of precipitating the acrylonitrile-butadiene-styrene copolymer from the acrylonitrile-butadiene-styrene copolymer solution by bringing the acrylonitrile-butadiene-styrene copolymer solution into contact with a non-solvent with an E_{score} value of 0 or less according to Equation 1.

7. The method of claim 6, further comprising a separation process of separating a solid material from the acrylonitrile-butadiene-styrene copolymer solution obtained by the dissolution process.

8. The method of claim 6, further comprising a rinsing process of rinsing the acrylonitrile-butadiene-styrene copolymer precipitated by the precipitation process.

9. A recycled acrylonitrile-butadiene-styrene copolymer extracted from the waste comprising the acrylonitrile-butadiene-styrene copolymer using the solvent screened by the method of claim 1.

10. The recycled acrylonitrile-butadiene-styrene copolymer of claim 9, comprising an additive derived from the waste.

11. A recycled acrylonitrile-butadiene-styrene copolymer composition comprising:
an acrylonitrile-butadiene-styrene copolymer extracted from a waste comprising the acrylonitrile-butadiene-styrene copolymer;
any one good solvent with an E_{score} value of more than 0 according to the following Equation 1; and
any one non-solvent with an E_{score} value of 0 or less according to the following Equation 1:
$${E}_{S c o r e} = {x}_{1} exp ( - m i x E ) + {x}_{2} [ log ( {x}_{3} {Mvol}^{a} ) + log ( {x}_{4} H S {P}^{b} ) ] + c \qquad [ Equation 1 ]$$
Wherein mixE is a mixing energy between the acrylonitrile-butadiene-styrene copolymer and the solvent,
Mᵥₒₗ is a molar volume of the solvent,
HSP is a Hansen solubility parameter,
X₁, X₂, X₃, and x₄ are each a real number from −1 to 1,
a and b are each a real number from 0 to 1, and
c is a real number from −10 to 10.

12. The recycled acrylonitrile-butadiene-styrene copolymer composition of claim 11, wherein the good solvent and the non-solvent each have a TD50 value for rats of 15 mg/kg or more calculated by the Discovery Studio TOPKAT Module of BIOVIA.

13. The recycled acrylonitrile-butadiene-styrene copolymer composition of claim 11, wherein the good solvent and the non-solvent each independently include-any one of an alcohol-based solvent, a ketone-based solvent, an ester-based solvent, an ether-based solvent, a polar nonprotic solvent, a hydrocarbon solvent, or a halogen-containing solvent.

14. The recycled acrylonitrile-butadiene-styrene copolymer composition of claim 11, wherein the good solvent comprises one or more of dimethyl sulfoxide, n-methyl-2-pyrrolidinone, n,n-dimethylacetamide, Tetrahydrofuran, 2-methylpyridine, 3,5-dimethylpyridine, acetylacetone, 1-methylimidazole, dimethyl isosorbide, gamma-valerolactone, 1,3-benzodioxole, diglyme, dichloromethane, chloroform, 1,1,2,2-tetrachloroethane, cyclopentanone, 2-cyclohexen-1-one, cyclohexanone, 2-pentanone, propanone, dimethylformamide, benzyl alcohol, carbon tetrachloride, 1,4-dioxane, trichloroethylene, butanone, oxalyl chloride, acetyl chloride, ethyl acetate, 3-methyl-2-butanone, 4-methylpyridine, acetyl acetate, 3-picoline, 2,3-pentanedione, morpholine, isopropyl acetate, pyrrole, 2-methylcyclopentanone, 2-methylpyrazine, cycloheptanone, 2,5-dimethylpyrazine, propanoic anhydride, 1,1-cthanediol diacetate, propionyl chloride, ethyl carbonochloridate, 1,1-dichloroethane, 3,6-dioxaoctane, 3,3-dimethyl-2-butanone, 3-methylcyclohexanone, 1,1-dichloro-2,2,2-trifluorocthane, chlorocthyl chloroformate, methyl dichloroacetate, dichloroacetyl chloride, tricthyl phosphate, dimethyl phthalate, chloroacetyl chloride, 3-chloropropanoyl chloride, methyl-5-(dimethylamino)-2-methyl-5-oxopentanoate, diethylene glycol diacetate, diethyl malate, dimethyl 1,4-cyclohexanedicarboxylate, diethyl adipate, diisopropyl methylphosphonate, dimethylcarbamoyl chloride, oxybis [chloromethane], isonicotinic acid ethyl ester, diethyl glutarate, ethylene sulfite, dimethyl adipate, dimethyl methylglutarate, ethyl succinate, n,n-diethyl-m-toluamide, 2-(2-ethoxyethoxy) ethyl acetate, ethyl chloroacetate, methoxyacetyl chloride, chloroacetic acid methyl ester, dimethyl glutarate, diethyl malonate, methyl carbonochloridate, methyl 2-hydroxybenzoate, 2-chlorophenol, ethyl oxalate, 2-acetyloxyethyl acetate, dimethyl succinate, 1,1,2-trichloroethane, 2-chloropyridine, 1-(2-hydroxyethyl) pyrrolidin-2-one, 2-[2-(diethylamino) ethoxy|ethanol, dimethyl malonate, 2,5-ditert-butylphenol, n-formylmorpholine, 4-morpholinepropanamine, 3,4-dihydrochromen-2-one, 3-methoxy-n,n-dimethylpropanamide, 4-(2-hydroxyethyl) morpholine, isopropyl acetoacetate, 2-acetylpyridine, 4-methoxyacetophenone, 3-methyl-2-oxazolidone, 1-ethoxy-2-(2-ethoxyethoxy) ethane, 2,6,6-trimethylcyclohex-2-ene-1,4-dione, 1,3-dimethyl-2-imidazolidinone, 3-methoxybutyl acetate, 2-isopropoxyethyl acetate, ethyl 3-ethoxypropionate, octahydrocoumarin, ethyl acetoacetate, 1-(2-hydroxyphenyl) ethanone, methyl benzoate, 1-(3-methoxypropoxy) propan-1-ol, n-sec-butylpyrrolidone, 2-methoxypropyl acetate, 2-ethoxyethanol acetate, 1-methoxy-2-propyl acetate, paraldehyde, tetramethylurea, methyl acetoacetate, 2-tert-butyl-4-methylphenol, 2-tert-butyl-5-methylphenol, 4-methoxyphenol, diethylene glycol monoethyl ether, 2-methoxyethyl acetate, diethyl carbonate, ethyl lactate, 1-tetralone, 2-tert-butylphenol, thymol, 3-tert-butylphenol, 2-methyl-5-propan-2-ylphenol, p-(sec-butyl) phenol, 1-ethylpyrrolidin-2-one, or 2-(2-methoxyethoxy) ethanol.

15. The recycled acrylonitrile-butadiene-styrene copolymer composition of claim 11, wherein the non-solvent comprises of one or more of 2-methylfuran, 1-methyl 1H-pyrrole, thiophene, diethylene glycol monobutyl ether, 2-butoxyethanol, methanol, ethanol, formamide, 2-[(2-methylpropan-2-yl) oxymethyl] oxirane, methyl lactate, 1,3-dithiolane, n-ethyl-morpholine, 2-methylindole, 3-ethyl-5-methylphenol, 2,4,5-trimethylphenol, ethyl 2-methylpropanoate, sec-butyl acetate, propyl propionate, ethyl butyrate, 2-methylpropyl acetate, n-butyl acetate, acetophenone, benzofuran, 4-isopropylpyridine, 3-methoxy-3-methyl-1-butanol, 1-(dimethylamino) propan-2-ol, methyl isobutyrate, methyl butyrate, ethyl propionate, propyl acetate, pyrimidine, 2,6-dimethylpyridine, 2,5-dimethylpyridine, 2,4-dimethylpyridine, 4-ethylpyridine, 3,4-dimethylpyridine, ethylene glycol methyl ethyl ether, 2,2-dimethoxypropane, 3-methoxy-1-butanol, 2-(dimethylamino)-ethanol, 1,1-dimethoxyethane, 1-hydroxypropan-2-one, 4-methylpentan-2-one, 3-hexanone, 2-hexanone, tetrahydrothiophene, 2,3-dihydropyran, 2-methyltetrahydrofuran, toluene, trimethylphosphine, benzene, 2-propanol, acetonitrile, or 2-methyl-1-buten-3-yne.
